(19) United States
(12) Patent Application Publication
(10) Pub. No.: US 2010/0038498 A1
(43) Pub. Date: Feb. 18, 2010

(54) CONFIGURABLE ANCHOR POINT AND MODULAR KIT FOR AN ANCHOR POINT

(75) Inventors: Don Enos, Ferndale, WA (US); Kathy Hughes, Ferndale, WA (US); Jason Kammerer, Bellingham, WA (US); Christopher D. Starr, Ferndale, WA (US); Garin Wallace, Ferndale, WA (US)

Correspondence Address: STOEL RIVES LLP - PDX, 900 SW FIFTH AVENUE, SUITE 2600, PORTLAND, OR, 97204-1268, US

(73) Assignees: Skedco, Inc., Tualatin, OR (US); Summit Rescue, Inc., dba Seattle Manufacturing Corporation, Ferndale, WA (US); Pigeon Mountain Industries, Inc., LaFayette, GA (US)

(21) Appl. No.: 12/542,521

(22) Filed: Aug. 17, 2009

Related U.S. Application Data
(60) Provisional application No. 61/089,838, filed on Aug. 18, 2008.

(51) Int. Cl. F16M 11/22

(52) U.S. Cl. 248/163.2

(57) ABSTRACT

Various components may be used to construct an artificial anchor point having a number of support legs. The support legs may articulate with respect to a plate assembly, may slide through a leg holder, may be telescopic, and may be configurable to conform to a variety of terrains. The support legs may be positionable horizontally with respect to a plate assembly for spanning a gap.

### RELATED APPLICATIONS

This application claims priority under 35 U.S.C. §119(e) to U.S. Provisional Application No. 61/089,838 titled Configurable Anchor Point and Modular Kit for an Anchor Point and filed on Aug. 18, 2008, which is fully incorporated by reference herein.

### TECHNICAL FIELD

The field of the present disclosure relates to a configurable anchor point and a modular kit for an anchor point.

### BACKGROUND

Artificial anchor points, typically used to attach ropes to, including running ropes through, when lifting or lowering an object, include gin poles, bi-pods, tri-pods, and other multi-legged pod configurations used when an elevated, or other, rigging anchor is needed for activities including mountain, military, and industrial rescue work, confined space entry, and caving. A conventional artificial anchor point may have a head secured to one or more legs and the head may have rigging anchors including holes for attachment points to attach ropes, carabiners, or other equipment. Devices such as pulleys may be attached to the holes using carabiners, and some heads may have a pulley attached directly to the head. Generally, a carabiner has a ring or D-shaped or C-shaped body including a gate that may be opened or closed. Using a carabiner to attach a pulley may reduce the height of the pulley above a surface and thus reduce the amount of clearance for lifting an object or injured person. Most conventional artificial anchor points have legs that are rigidly secured to the head, and some may provide one or a few articulated legs. But, conventional artificial anchor points do not provide articulation for all of the legs.

An artificial anchor point is typically used for rigging activities that employ ropes with a load attached to one end. An artificial anchor point may change the direction a rope is positioned, or running, and thus must be able to bear the load the rope is attached to. Artificial anchor points are typically used when there are no existing natural, or man-made, anchor points available to assist securing or moving the load attached to the rope. Artificial anchor points may be used in a variety of settings and terrains, and may be used for a variety of purposes, including rescue work and other impromptu jobs that require the artificial anchor point to adapt to un-anticipated terrain and conditions.

### SUMMARY

In a preferred embodiment, an artificial anchor point includes a head and leg holders pivotally attached to the head. A support leg may be slidably retained in each leg holder, and may be locked into place with respect to the leg holder in a variety of positions with different amounts of the support leg protruding on either side of the leg holder. The leg holders may preferably be locked in place in a variety of positions throughout their arcs of travel, thus independently changing the angular relationship of each support leg with respect to the head. Apertures or pulleys or other structure for retaining and/or guiding ropes may be included as part of the head or may be attached to the support legs.

Additional aspects and advantages will be apparent from the following detailed description of preferred embodiments, which proceeds with reference to the accompanying drawings.

### BRIEF DESCRIPTION OF THE DRAWINGS

FIG. 1A is a right side oblique view of a preferred construction of a monopod artificial anchor point.

FIG. 1B is a right side oblique view of a preferred construction of a bipod artificial anchor point.

FIG. 1C is a right side oblique view of a preferred construction of a tripod artificial anchor point.

FIG. 1D is a right side oblique view of a preferred construction of a quadpod artificial anchor point.

FIG. 2A is a right side view of a preferred main plate.

FIG. 2B is a left side rear oblique view of a preferred half plate.

FIG. 2C is a right side oblique view of a preferred offset leg holder.

FIG. 2D is a right side oblique view of a preferred centered leg holder.

FIG. 2E is a right side oblique view of a preferred lash ring.

FIG. 2F is a bottom oblique view of a preferred chain plate.

FIG. 2G is a right side view of a preferred foot.

FIG. 2H is a bottom oblique view of a preferred basket.

FIG. 2I is a right side view of a preferred support leg including a small leg tube and a large leg tube.

FIG. 3 is a left side view of a preferred half plate.

FIG. 4A is a top view of a preferred configuration for an artificial anchor point with the support legs in a horizontal position.

FIG. 4B is a right side view of the preferred configuration for an artificial anchor point of FIG. 4A with the support legs in a horizontal position.

FIG. 5A is a top view of another preferred configuration for an artificial anchor point with the support legs in a horizontal position.

FIG. 5B is a right side view of the preferred configuration for an artificial anchor point of FIG. 5A with the support legs in a horizontal position.

FIG. 6A is a front view of another preferred configuration for an artificial anchor point with the support legs in a non-horizontal position.

FIG. 6B is a right side view of the preferred configuration for an artificial anchor point of FIG. 6A with the support legs in a non-horizontal position.

FIG. 7A is a front view of another preferred configuration for an artificial anchor point with the support legs bypassing one another in a non-horizontal position.

FIG. 7B is a right side view of the preferred configuration for an artificial anchor point of FIG. 7A with the support legs bypassing one another in a non-horizontal position.

FIG. 8 is a right side view of a preferred embodiment of a pin used to construct preferred configurations for artificial anchor points.

FIG. 9A is a partially cut away right side view of a preferred pin installed in an aperture.

FIG. 9B is a partially cut away right side view of a preferred pin partially installed in an aperture.

FIG. 10A is a rear oblique left side view of another preferred configuration for an artificial anchor point with the support legs in a non-horizontal position.

FIG. 10B is a front view of the preferred configuration for an artificial anchor point of FIG. 10A with the support legs in a non-horizontal position.

FIG. 11A is a right side view of a preferred embodiment of a foot installed in a support leg.

FIG. 11B is a bottom view of the preferred embodiment of a foot of FIG. 11A installed in a support leg.

FIG. 11C is an exploded right side view of the preferred embodiment of a foot of FIG. 11A.

FIG. 11D is a right side view of a preferred embodiment of a foot installed and in alternate, rotated positions in a support leg.

FIG. 12A is a front view of another preferred configuration for an artificial anchor point with the support legs in another non-horizontal position.

FIG. 12B is a front view of the preferred configuration for an artificial anchor point of FIG. 12A with the support legs in another non-horizontal position.

FIG. 12C is a front view of the preferred configuration for an artificial anchor point of FIG. 12A with the support legs in another non-horizontal position.

FIG. 12D is a close-up right side oblique view of the preferred configuration for an artificial anchor point of FIG. 12A with the support legs in a non-horizontal position.

FIG. 13A is a right side view of a prior art placement for support legs.

FIG. 13B is a right side view of the artificial anchor point of FIG. 1 3A with the support legs holding a place to anchor a rope at approximately the same height above a surface as the main plate depicted in FIG. 13A.

### DETAILED DESCRIPTION OF PREFERRED EMBODIMENTS

Preferred embodiments will now be described with reference to the drawings. The preferred embodiments will be described in terms of an artificial anchor point and components for a kit for constructing artificial anchor points using preferred components. But, alternate components may be employed with artificial anchor points and kits for constructing artificial anchor points.

### Advantages And Features

Certain embodiments may provide an artificial anchor point capable of quickly and easily adapting to virtually any terrain and a variety of conditions. Other embodiments may provide an anchor point system that is modular, allows components to be placed where needed, is lightweight, packable, and strong. Yet other embodiments may permit each leg supporting an artificial anchor point to be independently adjustable from the other support legs, including the angular relationship of each support leg to the head and the length of each support leg both above and below the head. Further embodiments may include the ability to adjust the height and the foot print of an artificial anchor point to maintain the head at a consistent height while having different foot prints spanned by the support legs; having feet on the support legs that may adapt to different terrain without requiring a number of separate feet; and the ability to span horizontal distances.

The following detailed description of preferred embodiments describes preferred embodiments for an artificial anchor point that may address one or more of the above advantages or features, or may address different advantages or features.

### Preferred Configurations

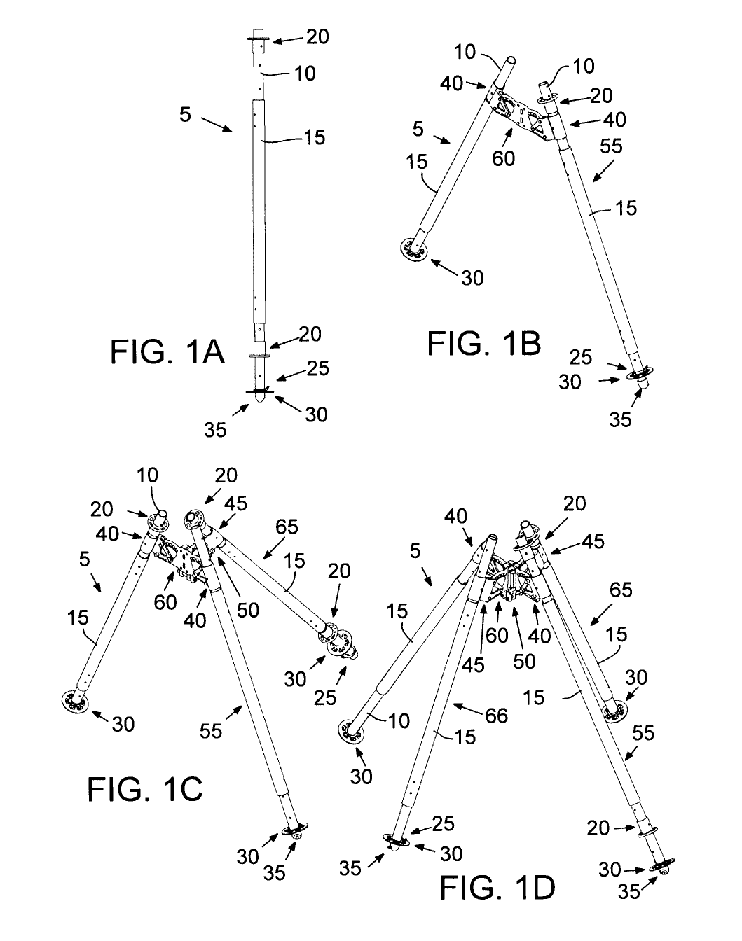

FIGS. 1A-1D illustrate preferred artificial anchor points having support leg configurations of one, two, three, and four support legs. A kit for an artificial anchor point may contain the components necessary to build any one of the anchor points illustrated in FIGS. 1A-1D, or any combination of the anchor points illustrated in FIGS. 1A-1D. Kits and details of the individual components are discussed below.

FIG. 1A illustrates a monopod, commonly referred to as a gin pole. The monopod configuration may include a support leg 5, including one or more small leg tubes 10 and a large leg tube 15, one or more lash rings 20, a chain plate 25, a basket 30, and a foot 35. Unlike existing gin poles that include only a few places to secure a rope at one end, embodiments of the monopod may include multiple lash rings 20, and the lash rings 20 may be located anywhere along the length of the small leg tube 10 and/or the large leg tube 15. Providing multiple lash rings 20, and the ability to locate a lash ring 20 anywhere along the length of the small leg tube 10 and/or the large leg tube 15 may permit embodiments of the monopod to be more easily and robustly secured in place and may provide better places to attach ropes or other equipment than previous gin poles. Another monopod configuration may include one or more leg holders 40, 45 slidably retained on the upper small leg tube 10. Alternatively, a half plate 50 may be pivotally attached to one of the leg holders 40, 45. Including one or more leg holders 40, 45 and/or a half plate 50 for a monopod configuration may provide additional places to attach load bearing devices such as carabiners, ropes, pulleys, swivels, or other equipment, and may make the monopod more versatile.

FIG. 1B illustrates a bipod configuration, also referred to as an “A-frame.” The embodiment illustrated in FIG. 1B includes a preferred head that includes a main plate 60 pivotally attached to two offset leg holders 40. Using two offset leg holders 40 may permit the support legs 5 and 55 to bypass one another, especially when the support legs 5 and/or 55 are in, or near, the horizontal position. Alternate embodiments may use two centered leg holders 45, or one centered leg holder 45 and an offset leg holder 40. Providing two pivotal support legs that may bypass one another and/or telescope may permit a bipod configuration to adapt to the terrain and permit a user to position the main plate 60 so that the main plate 60, and/or pulleys, such as a high-directional pulley, apertures, or other suitable mounting structures of the main plate 60, are placed in a load securing orientation. For example, a load securing orientation includes singularly or in any combination, an orientation that may prevent multiple ropes from interfering with one another, evenly balance loads on the main plate 60, prevent side loading (for example, a force on a pulley that is not substantially orthogonal to the pulley axis), or evenly distribute forces transferred through ropes to the support legs. The bipod configuration may include one or more lash rings 20, one or more chain plates 25, one or more baskets 30, and one or more feet 35 on the support legs 5 and 55. As with the monopod configuration (and the tripod and quadpod discussed below), multiple lash rings 20 may be located at any desired place on the support legs 5 and 55. In an alternate embodiment, a bipod may be constructed using two half plates 50 attached to one another instead of a main plate 60.

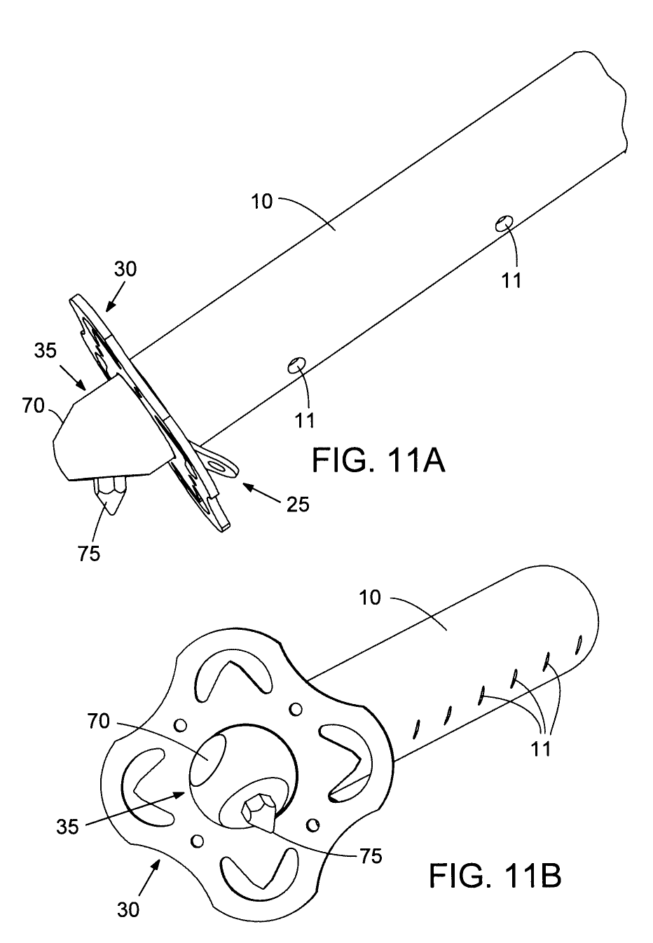

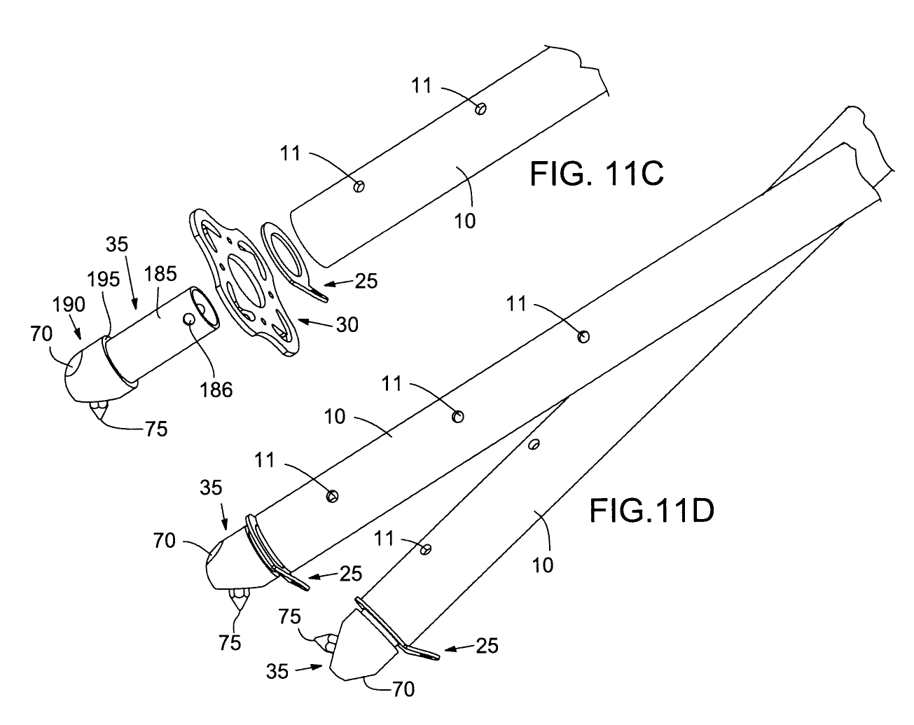

FIG. 1C illustrates a tripod configuration. The tripod configuration may include one or more lash rings 20, one or more chain plates 25, one or more baskets 30, and one or more feet 35 on the support legs 5, 55, and 65. Alternatively, the leg holders may be any combination of offset leg holders 40 and centered leg holders 45. As with the monopod and bipod configurations discussed above, and the quadpod configuration discussed below, the feet 35 may be retained in either a large leg tube 15 or in a small leg tube 10. Additionally, the feet 35 may be rotated to place a substantially smooth surface 70 or a spike 75 (FIG. 11A) on the surface supporting the tripod, depending on the characteristics of the surface supporting the tripod and the nature and orientation of the load being held by the tripod. In a preferred tripod configuration, the support legs 5, 55, and 65 may be positioned to leave room for a litter containing an injured person and an attendant for the litter between the support legs 5, 55, and 65. Other configurations, including bipod and quadpod configurations, may also accommodate a litter containing an injured person and an attendant for the litter between the support legs.

FIG. 1D illustrates a quadpod embodiment, which is similar to the tripod embodiment illustrated in FIG. 1C, but includes an additional half plate 50 attached to the main plate 60, an additional centered leg holder 45 pivotally attached to the additional half plate 50, and an additional support leg 66 slidably retained in the additional centered leg holder 45. The quadpod configuration may include one or more lash rings 20, one or more chain plates 25, one or more baskets 30, and one or more feet 35 on the support legs 5, 55, 65, and 66. Alternatively, the leg holders may be any combination of offset leg holders 40 and centered leg holders 45. Like the monopod, bipod, and tripod embodiments discussed above, providing a quadpod with support legs 5, 55, 65, and 66 that may pivot, telescope, and/or bypass one another may permit a quadpod configuration to adapt to the terrain and permit a user to position the main plate 60 so that pulleys, apertures, and/or other mounting structures are placed in a load securing orientation.

### Preferred Components

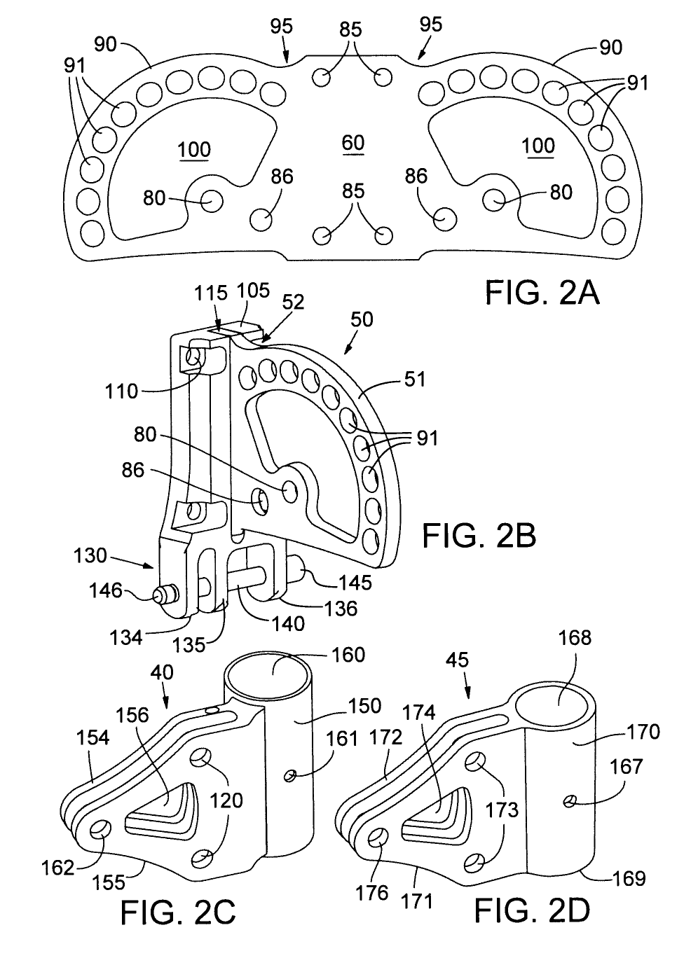

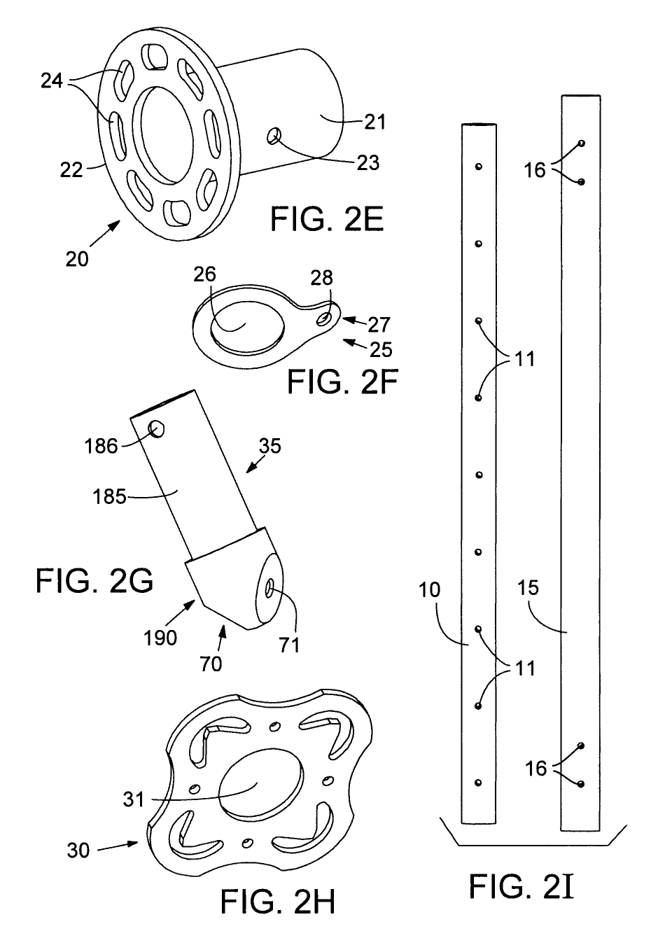

FIGS. 2A-2I illustrate ten preferred components that may be assembled in a variety of manners using one or more of each component to construct a monopod, bipod, tripod, quadpod, or other artificial anchor point. Not all of the components are needed to construct an artificial anchor point, and additional or different components may be used to construct an artificial anchor point.

### Head

A preferred head includes a main plate 60 illustrated in FIG. 2A that preferably includes two leg holder pivot apertures 80. Each of the pivot apertures 80 may permit a leg holder (40 or 45, discussed below) to be pivotally mounted to the main plate 60. The main plate 60 may also include half plate assembly connection apertures 85 for securing a half plate assembly 50, discussed below, to the main plate 60. While a preferred head is illustrated as including a plate, such as main plate 60, a head does not need to include a plate and may have other shapes suitable for supporting leg holders, such as leg holders 40 and 45 discussed below, or for supporting legs, such as legs 10 and 15. For example, a head may be substantially spherical and include wings, such as wings 90 or 51 (FIG. 2B), or slots for inserting wings.

The main plate 60 may also include two wings 90 protruding from opposite ends of the main plate 60. While the wings 90 are illustrated as directly opposed to one another, that is, in line with one another, the wings 90 may be secured to the main plate 60 at any angular relationship. Alternate embodiments may include a number of wings 90 other than two, for example, one, three, four, five, or more wings 90 may be included. The wings 90 may be formed as part of the main plate 60, for example, by machining the main plate 60 from a single piece of metal, by casting, or by forging, or the wings 90 may be secured by welding, bolts, or other suitable securement. Each wing 90 preferably includes a plurality of leg holder angle adjustment apertures 91, which are preferably arranged along an arc. One or more of the angle adjustment apertures 91 may be used to lock a leg holder (40/45) in a variety of positions throughout each leg holder's (40/45) arc of travel, as discussed below.

The main plate 60 may also include one or more leg divots 95. As discussed below, the leg divot 95 may act as a clearance or rest to provide space for a support leg to overly the wing 90 without contacting the wing 90, or to provide an additional brace for a support leg 10/15 (for example, one leg divot 95 may act as a clearance while another leg divot 95 acts as a rest) when a support leg is in a horizontal position and overlies or contacts the leg divot 95.

Recesses 100 may be included in the main plate 60. In certain configurations, the recesses 100 may be approximately 5 to 10 thousandths of an inch deep, and may serve as places to include writing such as instructions for assembling and using an artificial attachment point, logos, drawings, or other information. Written information may be engraved, stamped, or etched into the recesses 100, printed in the recesses 100, applied through a sticker, or other suitable manner for providing written information. Apertures 86 may be included in the main plate 60 to serve as places to attach load bearing devices such as carabiners, ropes, pulleys, swivels, or other suitable equipment. Preferably, a load bearing device transfers weight associated with a load, such as a patient in a litter or a person rappelling down the side of a structure, to an anchor point, such as the anchor point illustrated in FIG. 1C, and helps facilitate movement of such a load.

The preferred embodiment of the main plate 60 illustrated in FIG. 2A is approximately 16 inches long, 6 inches high, and ½ inch thick. The main plate 60 is preferably manufactured by Computer Numerical Control (CNC) machining a solid block of metal to the desired shape. The preferred material for the main plate 60 is 7075-T6 aluminum alloy. Other suitable dimensions, materials, and manufacturing techniques, such as casting or forging, may be used to construct alternate embodiments of the main plate 60. A preferred material and manufacturing technique is provided for the following preferred components. As with the preferred main plate 60, described above, the following preferred components may be made with other suitable dimensions, materials, and/or manufacturing techniques.

### Half Plate

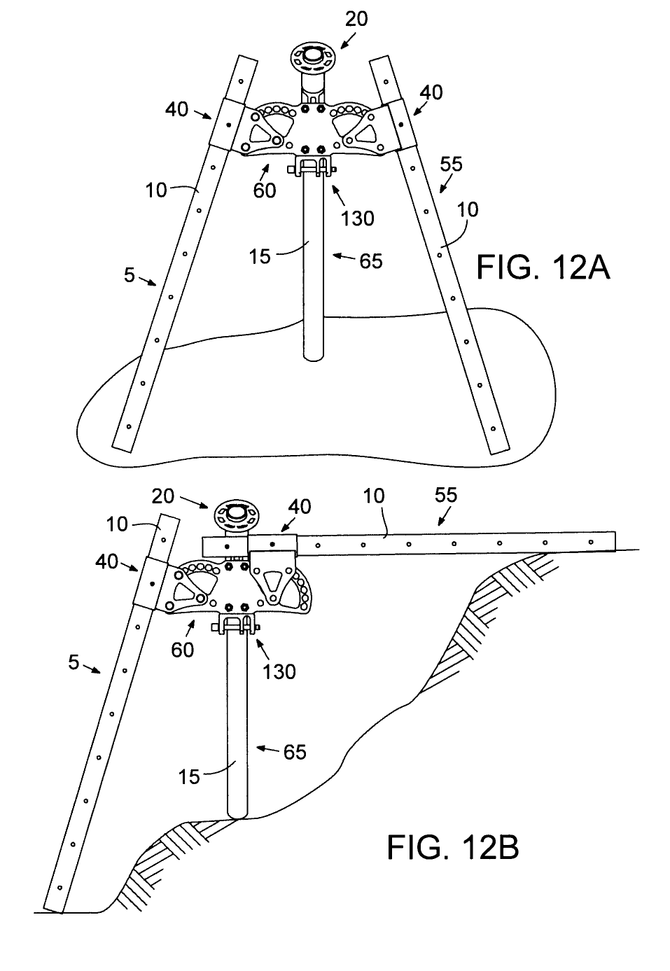

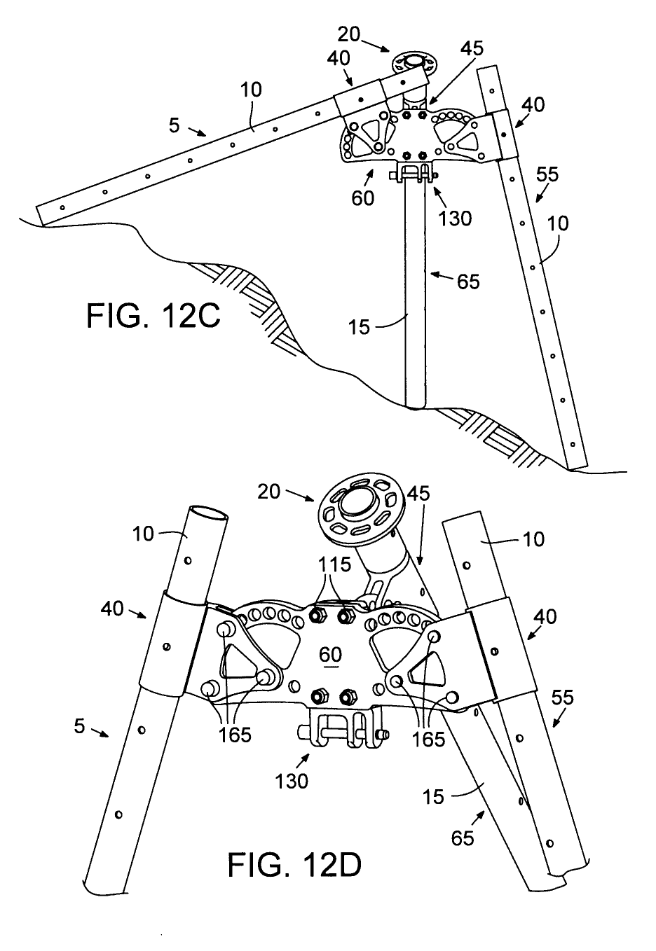

A half plate assembly 50 illustrated in FIG. 2B preferably includes one leg holder pivot aperture 80. The pivot aperture 80 may permit a leg holder (40 or 45, discussed below) to be pivotally mounted to the half plate 50. The half plate 50 may also include a bolt plate 105 that includes main plate assembly connection apertures 110. Countersinking the main plate assembly connection apertures 110 in the bolt plate 105 may prevent ropes or other equipment from rubbing against or snagging bolts (115, FIG. 12D) or rivets secured in the main plate assembly connection apertures 110. In a preferred embodiment, one or two half plates 50 may be bolted to a main plate 60 using the half plate assembly connection apertures 85 (FIG. 2A) and the main plate assembly connection apertures 110. In other embodiments, one or more half plates 50 may be riveted or welded to the main plate 60.

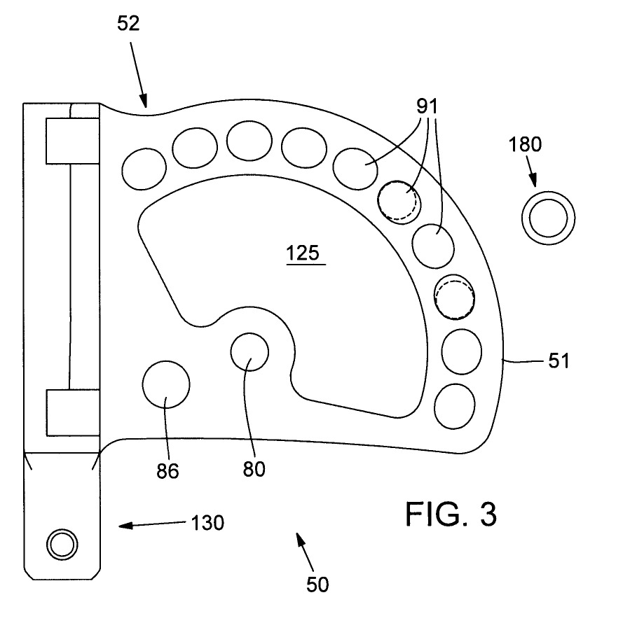

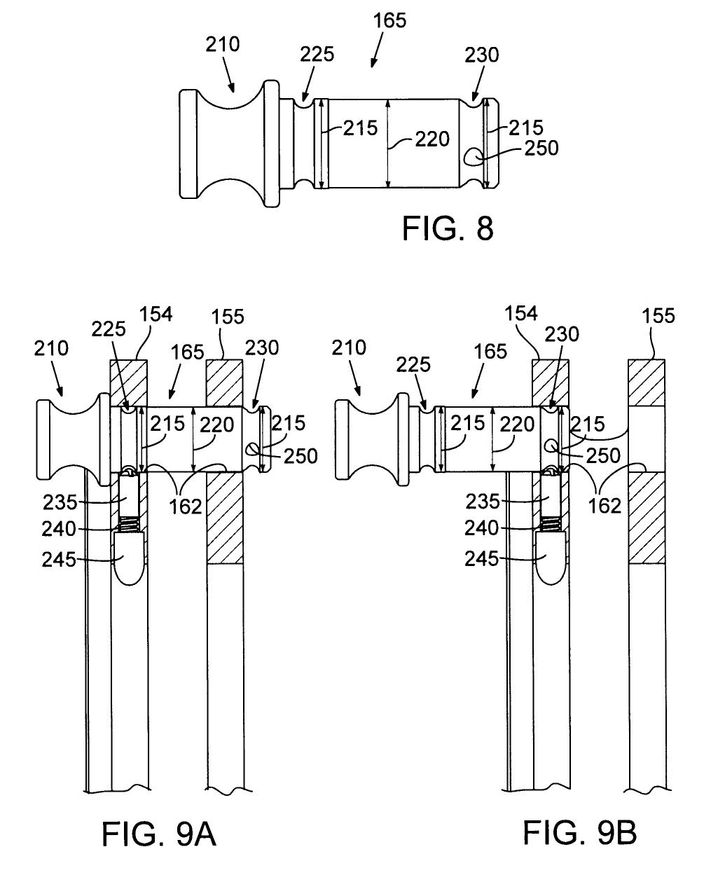

The half plate 50 may also include one wing 51 protruding from the bolt plate 105. While the wing 51 is illustrated as orthogonal to the bolt plate 105, the wing 51 and the bolt plate 105 may be at any angular relationship. In alternate embodiments, more than one wing 51 may be included on the half plate 50. In a preferred embodiment, the wing 51 slides into a slot 115 in the bolt plate 105, preferably with a slip fit. The wing 51 is bolted in place in a preferred embodiment, but may be riveted, welded, or secured in another suitable manner. In alternate embodiments, the wing 51 may be formed as part of the half plate 50, for example, by machining the half plate 50 from a single piece of metal, by casting, or by forging. The wing 51 preferably includes a plurality of leg holder angle adjustment apertures 91. Referring to FIG. 3, the angle adjustment apertures 91 (on both the half plate 50 and on the main plate 60) may be oval shaped to facilitate inserting a pin (such as pin 165, FIG. 8), bolt, rod, or other suitable element. One or more of the angle adjustment apertures 91 may be used to lock a leg holder (40/45) in a variety of positions throughout each leg holder's (40/45) arc of travel, as discussed below. Making the angle adjustment apertures 91 oval shaped may permit easier alignment between the angle adjustment apertures 91 and the locking apertures 120, 173 in the offset and centered leg holders 40, 45. Making the angle adjustment apertures 91 oval shaped may also permit the centered leg holder 45 and/or the offset leg holder 40 to lock in place without permitting substantial movement between a centered or offset leg holder 45, 40 and a main plate 60 or a half plate 50.

The half plate 50 may also include one or more leg divots 52. As discussed below, the leg divot 52 may provide clearance for a support leg to overly the wing 51 without contacting the wing 51, or may provide an additional brace for a support leg 10/15 when a support leg is in a horizontal position and overlies or contacts the wing 51.

The half plate 50 may include a recess 125, which is preferably 5 to 10 thousandths of an inch deep. In certain configurations, the recess 125 may serve as a place to include writing such as instructions for assembling and using an artificial attachment point, logos, drawings, or other information. Written information may be engraved, stamped, or etched into the recesses 125, printed in the recesses 125, applied through a sticker, or other suitable manner for providing written information. The half plate 50 may also include an aperture 86 to serve as a place to attach carabiners, ropes, or other equipment.

The half plate 50 may also include an integral attachment structure 130. In a preferred embodiment, the integral attachment structure 130 may include a first flange 134, a second flange 135, and a third flange 136. In other embodiments, only one or two of the flanges 134, 135, and 136 may be included on the half plate 50. Each flange 134, 135, and 136 preferably has an aperture therethrough, and each aperture is preferably aligned so that a pin 140 may pass through each flange 134, 135, and 136. The pin 140 may have an enlarged head 145 to prevent one end of the pin 140 from passing through the flanges 134, 135, and 136. The pin 140 may also be threaded on the end opposite of the enlarged head 145, and a cap nut 146 may be threaded into place after the pin 140 is passed through the flanges 134, 135, and 136 to prevent the pin 140 from withdrawing through the flanges 134, 135, and 136. The pin 140 may be used as an axel for a pulley (not shown) located between the flanges 134 and 135. Alternatively, one or more pulleys may be located between the flanges 135 and 136. The pin 140 may also be used to attach carabiners, ropes or other equipment.

In a preferred embodiment, the wing 51 connects to the bolt plate 105 by a press fit, interlocking tabs, and 3¼ inch diameter flat head bolts. The bolt plate 105 preferably connects to the main plate 5 by 4½ inch diameter socket head bolts. The bolt plate 105 is preferably approximately 8 inches long, 4 inches wide, and 1¼ inches thick. The preferred bolt plate 105 is manufactured by CNC machining a block of 6061-T6 aluminum alloy to the desired shape.

The preferred embodiment for a wing 51 measures approximately 8 inches long, 6 inches wide, and ½ inch thick. The preferred wing 51 is manufactured by CNC machining a block of 7075-T6 aluminum alloy to the desired shape.

### Offset Leg Holder

An offset leg holder 40 illustrated in FIG. 2C has a leg tube 150 and first and second flanges 154, 155. The leg tube 150 has an inner surface 160 sized to receive a support leg 10/15. One or more leg securing apertures 161 may be formed in the leg tube 150, and preferably traverses through both walls of the leg tube 150 on opposite ends of a diameter. The leg tube 150 is illustrated as having a circular cross-section, but may be configured of any suitable shape (for example, square, hexagonal, etc.) to mate with a support leg 10/15.

The first flange 154 and a second flange 155 are preferably attached to the leg tube 150. Preferably, each of the flanges 154 and 155 are at an angle with respect to the leg tube 150 so that a plane extending between the flanges 154 and 155, and parallel to planes defined by the flanges 154 and 155, does not intersect the midpoint of the leg tube 150. A purpose of offsetting the flanges 154 and 155 as previously described may be to permit a support leg 10/15 to be set off to the side of a wing 90 or a wing 51 instead of being positioned in a plane defined by the wing 90 or the wing 51.

As illustrated in FIG. 2C, the flanges 154 and 155 are preferably spaced apart to accommodate either a wing 90 or a wing 51 between the flanges 154 and 155. One of the flanges 154 or 155 may contact a wing 90 or a wing 51 when a wing 90 or a wing 51 is placed between the flanges 154 and 155, or neither flange 154 or flange 155 may contact the wing 90 or the wing 51, or both the flange 154 and the flange 155 may contact the wing 90 or the wing 51. The flanges 154 and 155 may include apertures 156 to reduce the weight of the offset leg holder 40, permit viewing of written material in a recess 100, 125, or secure a carabiner.

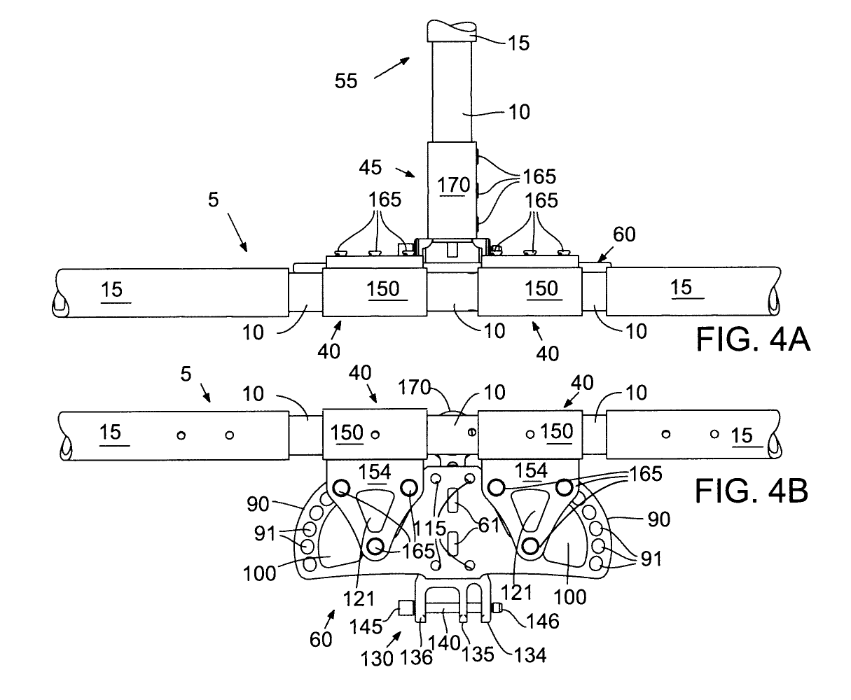

Both of the flanges 154 and 155 preferably include a pivot aperture 162, and the pivot aperture 162 is preferably approximately the same size as the leg holder pivot aperture 80 formed in the wing 90 or in the wing 51. The offset leg holder 40 may be pivotally secured to a main plate 60 or to a half plate 50 by a pin (such as pins 165, FIG. 4A), bolt, or rivet passing through the pivot apertures 162 and the leg holder pivot aperture 80. A pin or bolt may permit the offset leg holder 40 to be releasably, pivotally secured to a main plate 60 or to a half plate 50, whereas a rivet may fixedly, pivotally secure an offset leg holder 40 to a main plate 60 or to a half plate 50.

When an offset leg holder 40 is pivotally secured to a wing 90 or to a wing 51, an arc of travel for the offset leg holder 40 is defined by the wing 90 or the wing 51. Locking apertures 120 in the flange 154 and in the flange 155 may be included and spaced to align with the leg holder angle adjustment apertures 91 at various points along the arc of travel for the offset leg holder 40. One or more pins (such as pin 165, FIG. 8), bolts, or rods may pass through the locking apertures 120 and the leg holder angle adjustment apertures 91 to lock the offset leg holder 40 in a position along its arc of travel. Withdrawing the one or more pins, bolts, or rods from locking apertures 120 in one flange (for example, flange 155) and from the angle adjustment apertures 91 may permit the offset leg holder 40 to be pivoted to a new position along its arc of travel. In a preferred embodiment, one or more pins (165, FIG. 8), which are retained in the locking apertures 120 in the flange 154 as discussed below with reference to FIGS. 9A and 9B, may be reinserted through the leg holder angle adjustment apertures 91 and the locking apertures 120 in the flange 155 to lock the offset leg holder 40 in the new position.

A preferred embodiment of an offset leg holder 40 is a two part welded assembly. An approximately 2½ inch diameter tube 150 that is 5½ inches long is welded onto an approximately 5½ inch long by 5 inch wide by 1¼ inch thick slotted triangular member. The tube 150 is manufactured by sawing to a desired length and drilling the leg securing aperture 161 with an overhead drill press. The flanges 154 and 155 are formed by CNC machining the slotted triangular member. The preferred material for the offset leg holder 40 is 6061-T6 aluminum alloy.

### Centered Leg Holder

A centered leg holder 45 illustrated in FIG. 2D has a leg tube 170 and first and second flanges 171,172. The leg tube 170 has an inner surface 168 sized to receive a support leg 10/15. One or more leg securing apertures 167 may be formed in the leg tube 170, and preferably traverses through both walls of the leg tube 170 on opposite ends of a diameter. The leg tube 170 is illustrated as having a circular cross-section, but may be configured of any suitable shape (for example, square, hexagonal, etc.) to mate with a support leg 10/15.

The first flange 171 and a second flange 172 are preferably attached to the leg tube 170. Preferably, each of the flanges 171 and 172 are at an angle with respect to the leg tube 170 so that a plane extending between the flanges 171 and 172, and parallel to planes defined by the flanges 171 and 172, intersects the midpoint of the leg tube 170. A purpose of aligning the flanges 171 and 172 as previously described may be to permit a support leg 10/15 (singularly or in combination) to be positioned in a plane defined by the wing 90 or the wing 51.

As illustrated in FIG. 2D, the flanges 171 and 172 are preferably spaced apart to accommodate either a wing 90 or a wing 51 between the flanges 171 and 172. One of the flanges 171 and 172 may contact a wing 90 or a wing 51 when a wing 90 or a wing 51 is placed between the flanges 171 and 172, or neither flange 171 or flange 172 may contact the wing 90 or the wing 51, or both the flange 171 and the flange 172 may contact the wing 90 or the wing 51. Apertures 174 may be included in the flanges 171 and 172 to reduce the weight of the centered leg holder 45, permit viewing of written material in a recess 100, 125, or secure a carabiner.

Both of the flanges 171 and 172 preferably include a pivot aperture 176, and the pivot aperture 176 is preferably approximately the same size as the leg holder pivot aperture 80 formed in the wing 90 or in the wing 51. The centered leg holder 45 may be pivotally secured to a main plate 60 or to a half plate 50 by a pin, bolt, or rivet passing through the pivot apertures 176 and the leg holder pivot aperture 80. A pin or bolt may permit the centered leg holder 45 to be releasably, pivotally secured to a main plate 60 or to a half plate 50, whereas a rivet may fixedly, pivotally secure a centered leg holder 45 to a main plate 60 or to a half plate 50.

When a centered leg holder 45 is pivotally secured to a wing 90 or to a wing 51, an arc of travel for the centered leg holder 45 is defined by the wing 90 or the wing 51. Locking apertures 173 in the flange 171 and in the flange 172 may be included and spaced to align with the leg holder angle adjustment apertures 91 at various points along the arc of travel for the centered leg holder 45. One or more pins, bolts, or rods may pass through the locking apertures 173 and the leg holder angle adjustment apertures 91 to lock the centered leg holder 45 in a position along its arc of travel. Withdrawing the one or more pins, bolts, or rods from locking apertures 173 in one flange (for example, flange 171) and from the angle adjustment apertures 91 may permit the centered leg holder 45 to be pivoted to a new position along its arc of travel. In a preferred embodiment, one or more pins 165 (FIG. 8) are retained in the locking apertures 173 in the flange 172 as discussed above with reference to an offset leg holder 40.

A preferred embodiment of a centered leg holder 45 is a two part welded assembly. An approximately 2½ inch diameter tube 170 that is 5½ inches long is welded onto an approximately 5½ inch long by 5 inch wide by 1¼ inch thick slotted triangular member. The tube 170 is manufactured by sawing to a desired length and drilling the leg securing aperture 167 with an overhead drill press. The flanges 171 and 172 are formed by CNC machining the slotted triangular member. The preferred material for the centered leg holder 45 is 6061-T6 aluminum alloy.

### Lash Ring

A lash ring 20 illustrated in FIG. 2E has a tubular portion 21 and a flange portion 22. The tubular portion 21 is illustrated with a circular cross-section, but may be configured of any suitable shape (for example, square, hexagonal, etc.) to mate with a support leg 10/15. A lash ring locking aperture 23 preferably traverses both walls of the tubular portion 21 at opposite ends of a diameter. The lash ring locking aperture 23 is preferably approximately the size of support leg locking apertures 11 and 16, which are preferably approximately the same size.

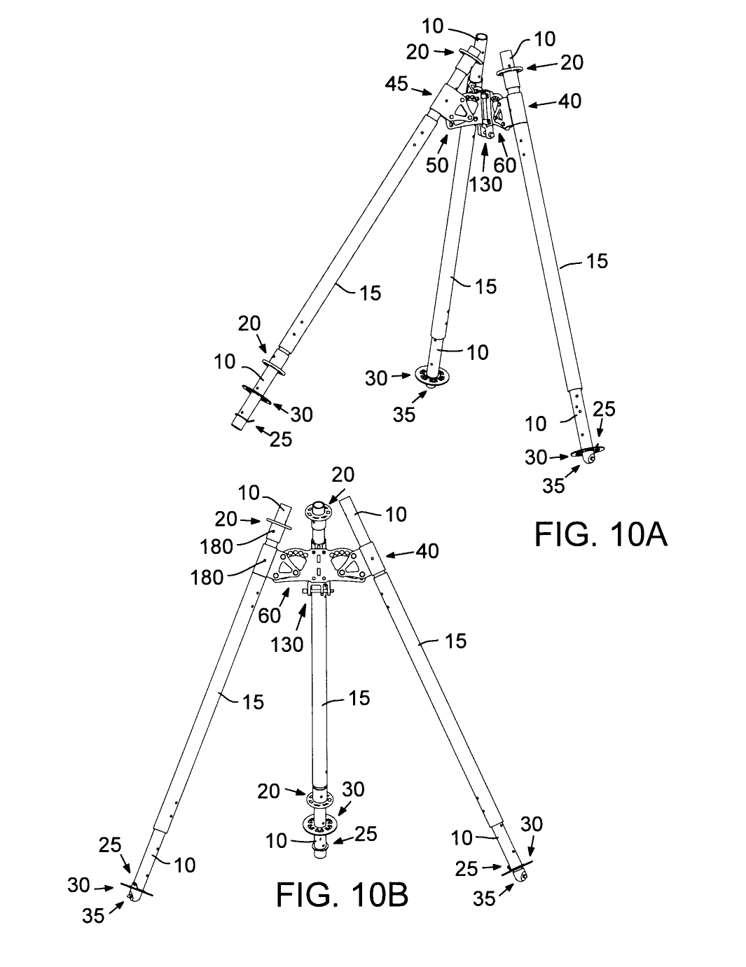

The lash ring 20 is preferably hollow, thus permitting the lash ring 20 to be placed anywhere along the length of a support leg 10/15 (for example, see FIG. 10A). Lash rings 20 may be sized to fit on either the small leg tube 10, the large leg tube 15, or both. A pin (such as pin 180, FIG. 3), bolt, or rod may pass through the lash ring locking aperture 23 and a support leg locking aperture 11 or 16 to lock the lash ring 20 in place on a support leg 10/15.

The flange 22 may include one or more lashing apertures 24. The lashing apertures 24 may be elongate, circular, or another shape. The lashing apertures may assist with stabilizing and/or securing an artificial anchor point, and/or may be used as a place to attach carabiners, ropes, or other equipment.

A preferred embodiment of a lash ring 20 is a two part welded assembly. An approximately 2½ inch diameter and 4 inch long tube 21 is welded onto an approximately 4½ inch diameter and ⅜ inch thick perforated circular flange 22. The tube 21 is manufactured by sawing a longer piece of tubing to length and drilling the lash ring locking aperture 23 with an overhead drill press. The perforated circular flange 22 is manufactured by CNC machining a disc of solid metal to the desired shape. The preferred material for the lash ring 20 is 6061-T6 aluminum alloy.

### Chain Plate

A chain plate 25 illustrated in FIG. 2F has a central aperture 26, a chain flange 27, and a chain aperture 28. Preferably, the central aperture 26 is sized to pass over a leg engaging section 185 of a foot 35. When a chain plate 25 is located on a foot 35, the chain plate 25 is preferably permitted to freely spin, and is not locked into position. Including a chain plate 25 on each foot 35, or alternatively on each support leg 10/15, and attaching a chain, rope, webbing, or other suitable element to each of the chain apertures 28 may assist preventing the support legs from spreading apart. Permitting the chain plates 25 to freely spin may allow each of the chain flanges 27 to point generally in the direction of a main plate 60 and/or a half plate 50, and may prevent torsional stress from being imparted to the support legs by the chain, rope, webbing, or other suitable element secured in the chain apertures 28.

A preferred embodiment for the chain plate 25 measures approximately 4 inches by 3 inches and is ⅛ inch thick. The preferred chain plate 25 is manufactured by CNC machining a disc of 4130 annealed steel alloy to the desired shape and dimensions.

### Foot

A foot 35 illustrated in FIG. 2G has a support leg engaging section 185 and a surface engaging section 190. The surface engaging surface 190 preferably includes a plurality of surface engaging features, such as relatively smooth foot surface 70 and spike 75 (FIG. 11A). The support leg engaging section 185 may be sized to fit within a support leg 10/15 or over a support leg 10/15. The support leg engaging section 185 does not need to be circular, and is preferably shaped and sized to mate internally with a support leg 10/15. A foot locking aperture 186 is preferably located in the support leg engaging section 185, and preferably traverses both walls of the support leg engaging section 185 on opposite ends of a diameter. The foot locking aperture 186 is preferably approximately the size of support leg locking apertures 11 and 16, which are preferably approximately the same size. A pin (such as pin 180, FIG. 3), bolt, or rod may pass through the foot locking aperture 1960 and a support leg locking aperture 11 or 16 to lock the foot 35 in place on a support leg 10/15.

Removing the pin, bolt, or rod from the foot locking aperture 186 and a support leg locking aperture 11 or 16 may permit the foot 35 to be rotated (see FIG. 11D). Rotating the foot 35 may permit a user to selectively engage the surface the artificial anchor point rests on with a surface engaging feature, such as a relatively smooth foot surface 70 or a spike 75. Replacing the pin, bolt, or rod into the foot locking aperture 186 and a support leg locking aperture 11 or 16 after rotating the foot 35 may lock the foot 35 in place with the selected surface engaging feature, such as the relatively smooth foot surface 70 or the spike 75, engaging the surface the artificial anchor point rests on.

The ground engaging section 190 may be made from a relatively soft material, such as aluminum or an aluminum alloy. The relatively smooth foot surface 70 is preferably made from the same material as the ground engaging section 190. The ground engaging section 190 may also include a threaded aperture 71. A spike 75 (FIG. 11A) may have threads that engage the threaded aperture 71. Including the spike 75 on the foot 35 may allow the foot 35 to have traction on surfaces, or grip surfaces, where the relatively smooth foot surface 70 does not provide satisfactory stability on, or engagement with, a surface. Alternate feet may be used in place of foot 35, and some embodiments may not require a foot at all.

A preferred embodiment for the foot 35 has an approximately 2½ inch diameter and 6 inch long support leg engaging section 185. The preferred embodiment is manufactured by CNC machining to form the lip 195 (FIG. 11C) and other features. The preferred material is 6061-T6 aluminum alloy. The preferred spike 75 measures approximately 9/16 inch wide and 2 inches long, and is manufactured by CNC machining a piece of heat treated 4130 steel alloy to the desired shape.

### Basket

When an artificial anchor point is used on a soft surface, for example, mud, sand, snow, or tundra, a basket 30 illustrated in FIG. 2H may be attached to one or more feet 35 or to support legs 10/15. Attaching a basket 30 to a foot 35 or to a support leg resting on a soft surface may decrease the distance the foot 35 and/or the support leg sinks into the soft surface.

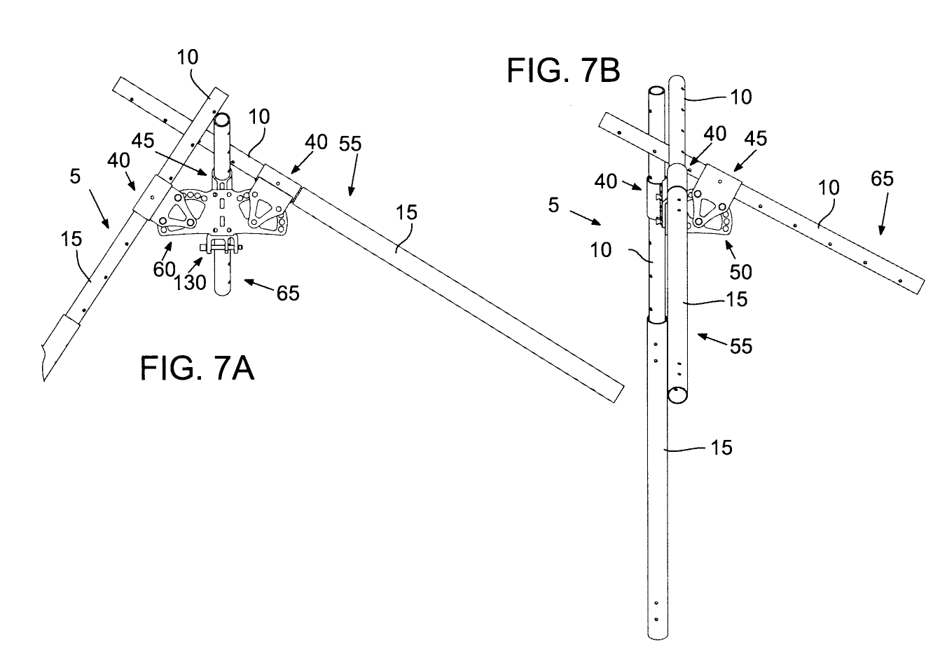

The basket 30 preferably has a central aperture 31 sized to fit around the leg engaging section 185 of a foot 35. In a preferred embodiment, the basket 30 is retained on a leg 10/15 by a lip 195 on the foot 35 and the end of the support leg (see FIGS. 7 and 8). The chain plate 25 is also preferably retained on a support leg by the lip 195 on the foot 35 and the end of the support leg (see FIGS. 11A-11C).

A preferred embodiment for the basket 30 measures approximately 6 inches in diameter and 3/16 inches thick. The preferred basket 30 is manufactured by CNC machining a sheet of general purpose nylon.

### Large & Small Leg Tubes

The support legs illustrated in FIG. 21 may include a large leg tube 15, a small leg tube 10, or a combination of large and small leg tubes 15/10. Preferably the small leg tube 10 slidably fits within the large leg tube 15, thus permitting support legs to telescopically extend and retract. The support legs may also slide through an offset leg holder 40 and/or a centered leg holder 45. An additional, preferred feature is that large leg tubes 15 and small leg tubes 10 may be assembled in any manner, and in any number as needed. For example, a large leg tube 15, a small leg tube 10, or both, may be slidably engaged with either a small leg tube 10 or a large leg tube 15, respectively, that protrudes through an offset leg holder 40 or a centered leg holder 45. Additionally, a large leg tube 15 or a small leg tube 10 may be slidably engaged on either side of an offset leg holder 40 or a centered leg holder 45.

As discussed below, telescoping the support legs and/or sliding the support legs through an offset leg holder 40 and/or a centered leg holder 45 may permit the height and/or orientation of a main plate 60 and/or a half plate 50 to be adjusted with respect to the surface an artificial anchor point rests on.

The large leg tube 15 may include support leg locking apertures 16. The small leg tube 10 may include support leg locking apertures 11. The number and position of the support leg locking apertures 11 and 16 is illustrated in a preferred configuration in FIG. 21, but the number and position of the support leg locking apertures 11 and 16 may vary. The support leg locking apertures 11 and 16 may be used to lock the large leg tube 15 in place with respect to the small leg tube 10 by inserting pins, bolts, rods, or other suitable elements through the support leg locking apertures 11 and 16. The support leg locking apertures 11 and 16 may also be used to retain the large leg tube 15 and the small leg tube 10 in either an offset leg holder 40 or a centered leg holder 45 as described above. The support leg locking apertures 11 and 16 may also be used to retain various components on the large leg tube 15 and the small leg tube 10 as described above.

Preferred embodiments of the large leg tube 15 and the small leg tube 10 are approximately 4 feet long with a 2½ inch diameter for the large leg tube 15 and a 2¼ inch diameter for the small leg tube 10. The large leg tube 15 and the small leg tube 10 are manufactured by sawing longer tubes to length and drilling the support leg locking apertures 11 and 16 with an overhead drill press. Both the large leg tube 15 and the small leg tube 10 are preferably made from 6061-T6 aluminum alloy.

### Additional Preferred Configurations

FIGS. 4A and 4B illustrate an artificial anchor point constructed using a main plate 60 with two offset leg holders 40 pivotally attached to the main plate 60, and a half plate 50 secured to the main plate 60 with one centered leg holder 45 pivotally attached to the half plate 50. The offset leg holders 40 are attached to the main plate 60 so that they are both offset on the same side of the main plate 60. Offsetting the two offset leg holders 40 on the same side of the main plate 60 permits a support leg 5, including a small leg tube 10 and a large leg tube 15, to be retained in each of the offset leg holders 40. One support leg 55 is secured in the centered leg holder 45 that is pivotally attached to the half plate 50. The support legs 5 and 55 are both in a horizontal position, that is, with the three leg holders 40, 45 pivoted to their uppermost position. The configuration illustrated in FIGS. 4A and 4B may be useful for spanning an open gap and providing an anchor point above the open gap. Including one support leg 5 in both of the offset leg holders 40 pivotally attached to the main plate 60 may provide a strong anchor point. Hardware, for example a ¾″ pulley, carabiners, a rope, or other equipment, may be attached to the pin 140, and may be used as rigging for lowering an object into the gap or raising an object out of the gap.

Alternate embodiments may use all centered leg holders 45, may eliminate the half plate 50, or may include a second half plate 50 attached to the main plate 60 with a fourth leg holder 40 or 45 pivotally attached to the second half plate 50. A third support leg may be retained in the fourth leg holder 40 or 45 in the horizontal, or other, position. Yet another alternate embodiment may include a separate support leg slidably retained in each of the three leg holders 40, 45 illustrated in FIGS. 4A and 4B.

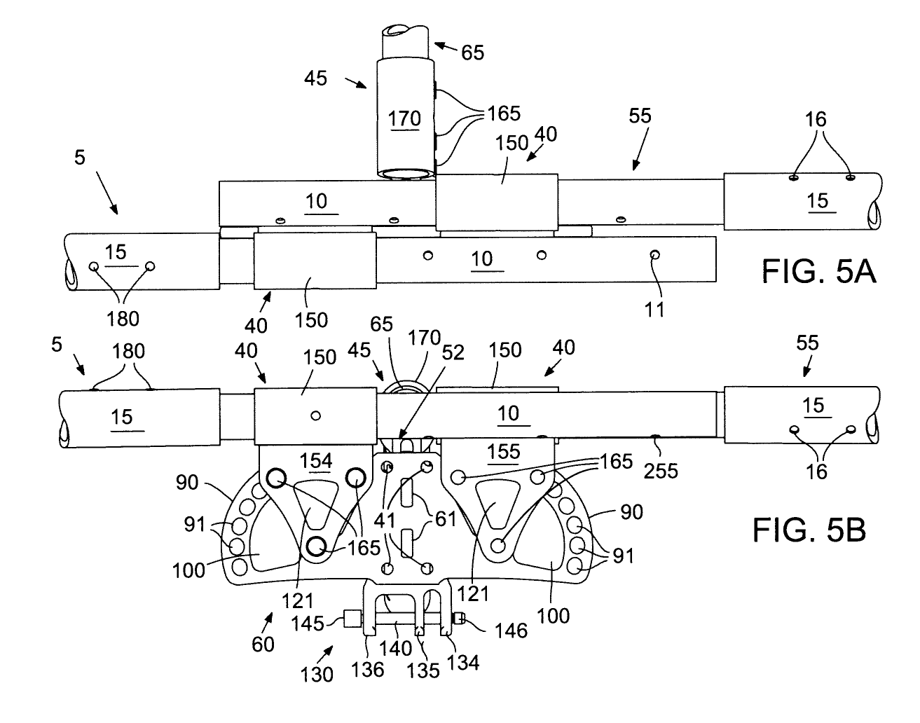

FIGS. 5A and 5B illustrate another artificial anchor point constructed using a main plate 60 with two offset leg holders 40 pivotally attached to the main plate 60, and a half plate 50 secured to the main plate 60 with one centered leg holder 45 pivotally attached to the half plate 50. In contrast to the embodiment illustrated in FIGS. 4A and 4B, the embodiment illustrated in FIGS. 5A and 5B includes the two offset leg holders 40 offset on opposite sides of the main plate 60. A support leg 5 and a support leg 55, both including a small leg tube 10 and a large leg tube 15, is retained in each of the offset leg holders 40. One support leg 65 is secured in the centered leg holder 45. The three support legs 5, 55, and 65 are in a horizontal position, that is, with the centered leg holder 45 and the two offset leg holders 40 pivoted to their uppermost position. The configuration illustrated in FIGS. 5A and 5B may be useful for spanning an open gap and providing an anchor point above the open gap.

By using offset leg holders 40 offset on either side of the main plate 60, the support legs 5 and 55 are permitted to bypass one another, as illustrated in FIG. 5A. The configuration illustrated in FIGS. 5A and 5B may provide an artificial anchor point that is stronger than the anchor point illustrated in FIGS. 4A and 4B because two support legs, in other words, the two side-by-side support legs 5 and 55, may span a gap instead of only one. The support leg 55 includes an end of the small leg tube 10 that extends through the offset leg holder 40 towards and past the centered leg holder 45. Where the support leg 55 overlies the half plate 50, the support leg 55 may rest in the leg divot 52 (FIG. 2B) in certain embodiments, or may not contact the leg divot 52 (FIG. 2B) in other embodiments. The leg divot 52 (FIG. 2B) may provide bracing, in addition to the two pins 165, to prevent the support leg 55 from pivoting when the support leg 55 contacts the leg divot 52 (FIG. 2B). Alternatively, the leg divot 52 (FIG. 2B) may prevent unwanted interference or contact between the half plate 50 and the support leg 55 when the support leg 55 does not contact the leg divot 52 (FIG. 2B).

Hardware, for example a ¾″ pulley, carabiners, a rope, or other equipment, may be attached to the pin 140, and may be used as rigging for lowering an object into the gap or raising an object out of the gap.

Alternate embodiments may include a second half plate 50 attached to the main plate 60 and a second centered leg holder 45 pivotally attached to the second half plate 50. A fourth support leg may be retained in the second centered leg holder 45 in the horizontal, or other, position. If a second half plate 50 is attached to the main plate 60, both of the support legs 5 and 55 attached to the offset leg holders 40 may have a leg divot 52 (FIG. 2B) available.

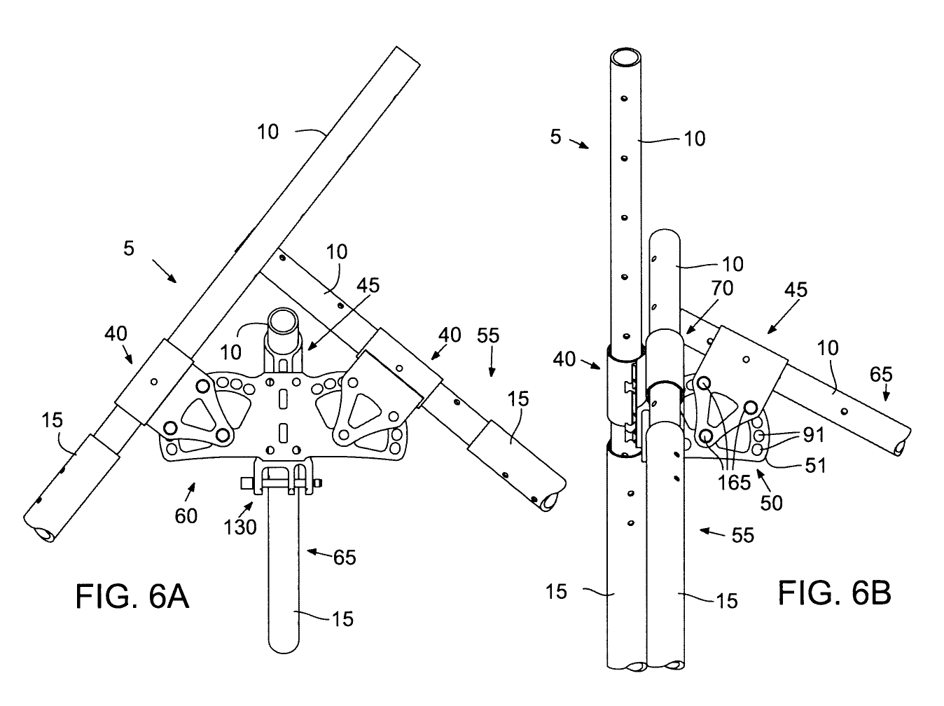

FIGS. 6A, 6B, 7A, and 7B depict an embodiment for a tripod configuration with the support legs 5, 55, and 65 in positions other than horizontal. The support legs 5, 55, and 65 are capable of being placed in horizontal positions, for example, similar to the embodiment illustrated in FIGS. 5A and 5B. As illustrated in FIGS. 6A, 6B, 7A, and 7B, the support legs 5, 55, and 65 may all bypass one another. The ability of the support legs 5, 55, and 65 to bypass one another above the main plate 60 and the half plate 50 may provide the anchor point with configuration features that permit the anchor point to be adapted to a variety of terrain and space limitations. For example, permitting the support legs 5, 55, and 65 to bypass one another may permit a user to extend the support legs 5, 55, and/or 65 above the main plate 60 and the half plate 50 to match surrounding terrain instead of removing sections, or potentially needing to cut portions, from the support legs 5, 55, or 65.

The support legs 5, 55, and 65 may also telescopically extend and retract. Permitting the support legs 5, 55, and 65 to both bypass one another above the main plate 60 and the half plate 50 and/or to telescope may permit the artificial anchor point to have increased flexibility regarding the height of the main plate 60 and the half plate 50 above a surface and to have increased flexibility regarding where the ends of the support legs 5, 55, and 65 are located on a surface. An anchor point having legs that bypass one another, telescope, and/or pivot may also permit a user to orient the main plate 60 and/or the half plate 50 in a desired direction. For example, a user may keep the main plate 60 and/or the half plate 50 substantially level (as illustrated in FIGS. 12A-12D) by adjusting the support legs 5, 55, and/or 65 to fit the terrain. Keeping the main plate 60 and/or the half plate 50 substantially level may prevent ropes from interfering with one another, may prevent unwanted or dangerous side loading, may evenly distribute a load to the support legs, and/or may direct the forces from loads attached to ropes between the legs of the anchor point. A user may also place the main plate 60 and/or the half plate 50 in load securing orientations other than substantially level depending on the terrain, space limitations, or rigging or other needs.

### Preferred Pin

FIGS. 8, 9A and 9B illustrate a preferred embodiment for a pin 165 used when constructing an artificial anchor point with the preferred components. In a preferred embodiment, the pin 165 is used as the pivot pin for both centered and offset leg holders 45, 40 and as the pin used to lock both centered and offset leg holders 45, 40 into position along their arc of travel. A different pin having a constant diameter is preferably used for locking a small leg tube 10 in place in a large leg tube 15, locking a foot 35 to a support leg 10 or 15, locking a lash ring 20 to a support leg 10 or 15, and as the pin to lock a support leg in an offset leg holder 40 or a centered leg holder 45. In other embodiments, the pin 165 may be used anywhere in the system where a pin, bolt, rod, or other suitable element is needed, including, but not limited to, locking an offset leg holder 40 or a centered leg holder 45 in a position along its arc of travel, locking a small leg tube 10 in place in a large leg tube 15, locking a foot 35 to a support leg 10 or 15, locking a lash ring 20 to a support leg 10 or 15, as the pivot point for an offset leg holder 40 or for a centered leg holder 45, and in place of the pin 180 (FIG. 3) to lock a support leg in an offset leg holder 40 or a centered leg holder 45.

The pin 165 is preferably 2¼ inches long and includes a grasping region 210 with a major diameter of ⅞ inch. A preferred embodiment of the pin 165 has a first pin diameter 215 that is approximately ⅝ inch in diameter, and a second pin diameter 220, which is smaller than the first pin diameter 215, preferably by 2 to 6 thousandths of an inch. A detent 255 is preferably formed in the first pin diameter 215, and a second detent 230 is preferably formed in the second pin diameter 220. The preferred embodiment is manufactured by CNC machining a rod of 6061-T6 aluminum alloy to the desired shape and dimensions.

The following discussion refers to an offset leg holder 40, but applies equally to a centered leg holder 45. In a preferred embodiment, an internal portion of the flange 154 (alternatively on the flange 155) proximate the pivot aperture 162 and the locking apertures 120 on the offset leg holder 40 (FIG. 2C) contains a pin retaining mechanism, such as a spring 240 secured to a stop 245 and a follower 235, that communicates with the pivot aperture 162. When the pin 165 is inserted into the pivot aperture 162 (or the locking apertures 120), the end of the pin 165 pushes the follower 235 towards the stop 245. When the detent 230 aligns with the follower 235, the spring 240 forces the follower 235 into the detent 230 (FIG. 9B), which retains the pin 165 in the pivot aperture 162 (or the locking apertures 120) in a “parked” position, that is, with a reduced risk that the pin 165 will fall out of the pivot aperture 162 (or the locking apertures 120). Providing the pin 165 with a “parked” position may allow the leg holder 40 to be stored with the pins 165 in a ready position, that is, not loose in a bag, but in a position where a user simply needs to push the pin 165 through an aperture when the pivot aperture 162 or locking aperture 120 is aligned with another aperture. As the pin 165 is further inserted into the pivot aperture 162 (or locking aperture 120), the surface of the pin 165 again pushes the follower 235 towards the stop 245. When the detent 225 aligns with the follower 235, the spring 240 forces the follower 235 into the detent 225 (FIG. 9A), again retaining the pin 165 in the pivot aperture 162 (or locking aperture 120) with a reduced risk that the pin 165 will fall out of the pivot aperture 162 (or locking aperture 120).

When a load is applied to the pin 165 while the pin 165 is in an aperture, for example the pivot aperture 162, the end of the pin 165 opposite the grasping region 210 may be slightly moved with respect to the end proximate the grasping region 210 because of the smaller second pin diameter 220. Such a slight movement may misalign the pin 165 from the central axis of the aperture and apply a differential force at the opposite ends of the pin 165 sufficient to “lock” the pin 165 in place. Thus, the smaller second pin diameter 220 may help retain the pin 165 in place when the pin 165 is inserted into an aperture and a load is applied to the pin 165.

The pin 165 may also include a cotter key hole 250 to permit a cotter key, or other suitable element, to assist retain the pin 165 in place.

### Footprint

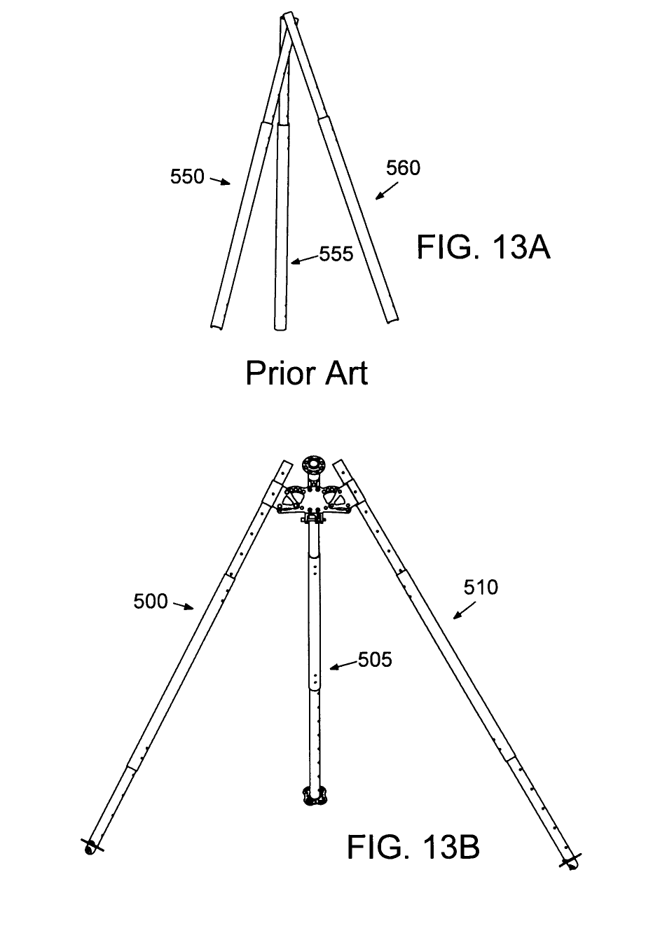

FIGS. 13A and 13B illustrate various footprints. FIG. 13A is an illustration of a prior art configuration where three legs come together at a common point and used to lift a load. In the embodiment illustrated in FIG. 13B, the footprint or working area, that is, the space between the legs 500, 505, and 510 is preferably large enough to accommodate a litter bearing an injured person as well as an attendant for the litter. The embodiment illustrated in FIG. 13B is capable of suspending ropes and other equipment at the same height as the configuration illustrated in FIG. 13A. However, the embodiment of FIG. 13B may be modified to have a footprint or working area between the legs 500, 505, and 510 similar to the footprint illustrated in FIG. 13A to fit into a confined area. Thus, one advantage certain embodiments may provide over the prior art is adjustability for both footprint and working height to provide an enlarged work area underneath an artificial anchor point, a constant working height for an artificial anchor point, or both.

### Kits

A kit may include several components that may be assembled to construct an artificial anchor point, or to construct several artificial anchor points. The number and types of components in a kit may vary depending on the artificial anchor points to be built, the weight of the kit, and other factors.

In a preferred embodiment, a kit for an artificial anchor point includes in a main bag: (1) a head and accessory bag, (2) a single leg bag, and (3) a double leg bag. The head and accessory bag preferably contains a main plate 60, a half plate 50, one offset leg holder 40, two centered leg holders 45, and a chain or rope for running through chain plates 25. The offset leg holder 40 and the centered leg holders 45 may each have three pins 165 (FIG. 8) that are in a “parked” position, that is, the pins 165 may be partially inserted in the leg holders 40, 45 so that detents 230 cooperate with followers 235 to retain the pins in the leg holders 40, 45 instead of the pins being loose in the head and accessory bag. A number of loose pins (similar to pin 180, FIG. 3) having a substantially constant diameter shaft may be contained in the head and accessory bag, and may be used to pin components other than the leg holders 40, 45 to the main plate 60 and/or the half plate 50, for example, to pin a lash ring to a support leg.

The single leg bag preferably contains a large leg tube 15 and two small leg tubes 10. A foot 35, a basket 30, and a chain plate 25 are preferably pinned in place on one of the small leg tubes 10. A centered leg holder 45 is preferably pinned in place on the small leg tube 10 that bears the foot 35. The centered leg holder 45 preferably contains three pins 165 (FIG. 8) that are in a “parked” position, that is, the pins 165 may be partially inserted in the leg holder 45 so that detents 230 cooperate with followers 235 to retain the pins in the pivot aperture 176 and the locking apertures 173 instead of the pins being loose in the single leg bag. Additional pins for locking the small leg tubes 10 in the large leg tube 15 may also be included in the single leg bag.

The double leg bag preferably contains two large leg tubes 15 and four small leg tubes 10. A foot 35, a basket 30, and a chain plate 25 are preferably pinned in place on two of the small leg tubes 10. An offset leg holder 40 is preferably pinned in place on the two small leg tubes 10 that bear the feet 35. The offset leg holders 40 preferably contain three pins 165 (FIG. 8) that are in a “parked” position, that is, the pins 165 may be partially inserted in the leg holder 40 so that detents 230 cooperate with followers 235 to retain the pins in the pivot apertures 162 and the locking apertures 120 instead of the pins being loose in the double leg bag. Additional pins for locking the small leg tubes 10 in the large leg tube 15 may also be included in the single leg bag. More or fewer small leg tubes 10 and large leg tubes 15 may be supplied for each of the single and double leg bags.

If a tripod anchor point is needed, a user may grab the main bag and transport it to the site where the tripod anchor point will be used. However, if only a bipod anchor point is needed, a user may grab the head and accessory bag and the double leg bag out of the main bag and transport them to the site where the bipod anchor point will be used. Or, if a gin pole is needed, a user may grab the head and accessory bag and the single leg bag out of the main bag and transport them to the site where the gin pole will be used. By compartmentalizing the components into several gear bags, it is possible for users to grab only the components needed for a particular job, which may reduce the amount of weight that needs to be transported to a job site, and may assist users to more quickly assemble the desired anchor point configuration by reducing the number of parts that need to be sorted through. Alternate kits may contain different component distributions and/or a different number of bags.

It will be obvious to those having skill in the art that many changes may be made to the details of the above-described embodiments without departing from the underlying principles of the invention. The scope of the present invention should, therefore, be determined only by the following claims.

1. An artificial anchor point comprising:
a head including a first wing and a second wing;
a first leg holder pivotally connected to the first wing, the first leg holder pivoting along a first arc of travel;
a second leg holder pivotally connected to the second wing, the second leg holder pivoting along a second arc of travel;
a first locking mechanism that selectively locks the first leg holder in a selected position and prevents the first leg holder from pivoting along the first arc of travel when locked;
a second locking mechanism that selectively locks the second leg holder in a selected position and prevents the second leg holder from pivoting along the second arc of travel when locked;
a first support leg slidably retained in the first leg holder;
a third locking mechanism that selectively locks the first support leg in the first leg holder and prevents the first support leg from sliding in the first leg holder when locked;
a second support leg slidably retained in the second leg holder; and
a fourth locking mechanism that selectively locks the second support leg in the second leg holder and prevents the second support leg from sliding in the second leg holder when locked.

2. An artificial anchor point according to claim 1, wherein the first leg holder and the second leg holder are pivotable such that the first support leg and the second support leg lie in a common plane.

3. An artificial anchor point according to claim 1, wherein the first wing and the second wing lie substantially in a common plane.

4. An artificial anchor point according to claim 3, wherein the head includes a plate and the first leg holder is offset to a first side of the plate and the second leg holder is offset to an opposite side of the plate.

5. An artificial anchor point according to claim 4, wherein the first support leg and the second support leg bypass one another when the first support leg and the second support leg are extended above the head.

6. An artificial anchor point according to claim 1, wherein the first support leg includes a first section and a second section, the first section slidably retained in the second section, and wherein the second support leg includes a first section and a second section, the first section slidably retained in the second section; and further comprising
a fifth locking mechanism that selectively locks the first section and the second section of the first support leg in place and prevents the first section from sliding in the second section when locked; and
a sixth locking mechanism that selectively locks the first section and the second section of the second support leg in place and prevents the first section from sliding in the second section when locked.

7. An artificial anchor point according to claim 1, further comprising:
a foot releasably attached to an end of the first support leg;
wherein the foot includes at least two surface engaging features and is releasably attached to the first support leg to permit one surface engaging feature engage a surface on which the artificial anchor point rests.

8. An artificial anchor point according to claim 7, wherein one surface engaging feature includes a relatively smooth surface and another surface engaging feature includes a spike.

9. An artificial anchor point according to claim 7, further comprising:
a second foot releasably attached to an end of the second support leg;
a first chain plate rotatably secured between the first leg and the first foot; and
a second chain plate rotatably secured between the second leg and the second foot.

10. An artificial anchor point according to claim 7, further comprising:
a first basket secured between the first leg and the first foot; and
a second basket secured between the second leg and the second foot.

11. An artificial anchor point according to claim 1, further comprising:
a lash ring positionable at multiple positions on the first leg and releasably secured at one of said multiple positions on the first leg.

12. An artificial anchor point according to claim 1, further comprising:
a third wing connected to the head;
a third leg holder pivotally connected to the third wing, the third leg holder pivoting along a third arc of travel;
a fifth locking mechanism that selectively locks the third leg holder in position and prevents the third leg holder from pivoting along the third arc of travel when locked;
a third support leg slidably retained in the third leg holder; and
a sixth locking mechanism that selectively locks the third support leg in the third leg holder and prevents the third support leg from sliding in the third leg holder when locked.

13. An artificial anchor point according to claim 12, wherein the first, second, and third legs are selectively slidably and pivotally adjustable to maintain the head in a load securing orientation regardless of a contour of a surface on which the artificial anchor rests.

14. An artificial anchor point according to claim 1, wherein:
the first locking mechanism includes a first lock aperture in the first leg holder, a second lock aperture in the first leg holder and substantially aligned with the first lock aperture, (1) one of a plurality of leg holder angle adjustment apertures in the plate, and (2) a pin sized to fit through the first and second lock apertures and the one of the plurality of leg holder angle adjustment apertures.

15. An artificial anchor point according to claim 14, wherein:
the first locking mechanism further includes a pin retaining mechanism in the first leg holder that communicates with the first lock aperture; and
the pin includes a first detent and a second detent, wherein the pin retaining mechanism engages the first detent to hold the pin in place when the first locking mechanism is locked and wherein the pin retaining mechanism engages the second detent to hold the pin in place when the first locking mechanism is unlocked.

16. An artificial anchor point according to claim 14, wherein the pin further includes a first pin diameter and a second pin diameter that is smaller than the first pin diameter, and the first pin diameter and the second pin diameter are sized to permit an end of the pin to become misaligned with respect to a central axis of the first and second lock apertures to lock the pin in place when a load is applied to the first leg.

17. A method of setting up an artificial anchor point comprising:
pivotally attaching a first leg holder to a head;
slidably retaining a first support leg in the first leg holder with a top portion of the first support leg protruding out one side of the first leg holder and a bottom portion of the first support leg protruding out of an opposite side of the first leg holder;
pivotally attaching a second leg holder to the head;
slidably retaining a second support leg in the second leg holder with a top portion of the second support leg protruding out one side of the second leg holder and a bottom portion of the second support leg protruding out of an opposite side of the second leg holder;
attaching a load bearing device; and
pivoting and sliding the first support leg and the second support leg as needed to match surrounding terrain to locate the head at a desired position and load securing orientation to lift a load with forces from the load acting on the load bearing device.

18. A method according to claim 17, wherein the load securing orientation is substantially horizontal.

19. A method according to claim 17, wherein the load bearing device is selected from the group consisting of a pulley, a carabiner, a swivel, and a rope.

20. A method according to claim 17, further comprising:
pivotally attaching a third leg holder to the head;
slidably retaining a third support leg in the third leg holder with a top portion of the third support leg protruding out one side of the third leg holder and a bottom portion of the third support leg protruding out of an opposite side of the third leg holder; and
wherein pivoting and sliding further includes pivoting and sliding the third support leg as needed to match surrounding terrain to locate the head at a desired position and load securing orientation to lift a load with forces from the load acting on the load bearing device.
